(19) United States
(12) Patent Application Publication
(10) Pub. No.: US 2007/0062109 A1
(43) Pub. Date: Mar. 22, 2007

(54) Permanent underground staking system and apparatus for vines and weakly rooted trees

(76) Inventor: Wesley B. Jolley, Loxahatchee, FL (US)

Correspondence Address: ROBERT M. DOWNEY, P.A., 6751 N. FEDERAL HWY., SUITE 300, BOCA RATON, FL, 33487, US

(21) Appl. No.: 11/501,539

(22) Filed: Aug. 9, 2006

Related U.S. Application Data
(60) Provisional application No. 60/709,059, filed on Aug. 17, 2005.

(51) Int. Cl. A01G 17/14

(52) U.S. Cl. 47/47

(57) ABSTRACT

A staking system for vines and weakly rooted trees provides a rigid structure having a vertical extension and a base at the bottom end. The overall length of the base is about half of the overall height of the vertical extension. The rigid structure may further include one or more branch members extending from the top end of the vertical extension. In use, the rigid staking structure can be fitted below a planting pot with the base extending out below the bottom of the pot and the vertical extension extending up through the planting pot. Tree stems or vines growing in the pot are braided around the vertical extension. Similarly, vines or branches can be trained to grow out along the branch extensions of the rigid structure to form an ornamental treetop. When fully grown around the vertical extension, a trunk is formed which conceals the rigid staking structure. Eventually, the lower portion of the vertical extension and the base are planted underground with the root system of the tree to provide a permanent underground staking system which is firmly anchored, concealed from view, extremely strong and long lasting.

### BACKGROUND OF THE INVENTION

1. Field of the Invention

The present invention relates to staking systems and, more particularly, to a system and apparatus that provides a staking structure formed of rigid steel bars including a vertical extension and three or more legs extending perpendicularly from the bottom end of the vertical extension. A tree or vines grow up and around the vertical extension and eventually branch out to form an ornamental tree top, while the legs are buried underground to firmly anchor and support the staking system and the planted tree.

2. Discussion of the Related Art

Some trees and vines have weak or shallow root systems that are unable to provide adequate support as the tree grows larger. Eventually, the top weight of the tree will cause the tree to lean to one side and possibly fall to the ground, particularly in high winds and/or heavy rains. To prevent this, one or more stakes are driven into the ground and tied to the trunk or stem of the tree. In some instances, a single stake or trellis is used directly adjacent to the trunk or growing vines. This is commonly used for bougainvillea trees and bushes. Other staking methods for trees use between two and four stakes that are driven into the ground at a spaced distance from the base of the tree. The stakes are then tied to the upper trunk of the tree in order to hold the tree in the upright position.

The various staking methods presently used to support weakly rooted trees have several drawbacks and undesirable features. Most notably, presently used staking methods are cumbersome, unsightly and detract from the ornamental appearance of the trees they support. Also, the staking methods used for supporting trees are not suitable for use at the early growing stages. In most instances, stakes are used after the tree has grown and is planted in the ground. Bougainvillea and other weakly rooted trees are often potted with a wood trellis which remains visible at all times, even after the tree is planted in the ground. Eventually, the wooden trellis deteriorates and may break from the weight of the growing bush or tree. Bougainvillea, in particular, will grow large and become top heavy. Eventually, the trellis will be unable to provide adequate support to hold the bougainvillea plant upright.

Accordingly, there remains an urgent need in the field of nurseries and gardening for a permanent underground staking system for vines and weakly rooted trees which is concealed from view, extremely strong, long lasting, and which firmly anchors a fully grown tree in an upright position while withstanding high winds and heavy rains.

### OBJECTS OF THE INVENTION

Considering the foregoing, it is a primary object of the present invention to provide a permanent staking system for vines and weakly rooted trees which can be installed below a planting pot with the vertical rigid support extending up through the pot and the legs below the pot and extending outwardly so that the growing vines or tree can be braided about the vertical rigid support of the staking system, and wherein the staking system and tree are eventually planted in the ground to provide a permanent underground staking system which firmly anchors a fully grown tree in an upright position, while remaining concealed from view.

It is a further object of the present invention to provide an extremely strong and permanent staking system for vines and weakly rooted trees which can be used to grow expensive specimen trees, such as bougainvillea.

It is a further object of the present invention to provide a rigid, extremely strong staking system for vines and weakly rooted trees which is adapted for use by both professional nurseries and gardening enthusiasts.

It is a further object of the present invention to provide a permanent underground staking system for vines and weakly rooted trees which is adapted to be installed below a planting pot with a vertical support of staking system expanding up through the pot and the legs extending outwardly (horizontally) below the pot to allow the vines or tree stems to grow and braid around a rigid vertical extension of the staking system, and wherein the staking system can subsequently be permanently planted underground in order to firmly anchor and continually support a growing tree in an upright position while withstanding high winds and heavy rains.

It is still a further object of the present invention to provide a permanent underground staking system for vines and weakly rooted trees which remains concealed from view once the tree or vines have grown up and around the rigid vertical extension of the staking system to form a tree trunk.

It is still a further object of the present invention to provide a staking system which allows vines and weakly rooted trees to grow into highly desirable and ornamental specimen trees, and wherein the staking system can be permanently planted with the trees to provide a rigid, extremely strong skeletal structure which firmly anchors the tree in an upright position.

These and other objects and advantages of the invention are readily apparent with reference to the drawings and the detailed description which follows.

### SUMMARY OF THE INVENTION

The present invention is directed to a staking system for vines and weakly rooted trees. Specifically, the staking system provides a rigid structure having a vertical extension and a base. In a preferred embodiment, the base includes three or more legs extending generally perpendicular to the vertical extension at the bottom end. The length of each leg is half of the overall height of the vertical extension. The rigid structure may further include one or more branch members extending from the top end of the vertical extension. In the preferred embodiment, the rigid structure is formed of steel reinforcing bars that are commonly referred to as rebar in the construction industry. In use, the rigid staking structure can be fitted below a planting pot with the legs extending out below the bottom of the pot and the vertical extension extending upwardly thorough the bottom of the pot and up through the open top of the pot. Tree stems or vines growing in the pot are braided around the vertical extension. Similarly, vines or branches can be trained to grow out along the branch extensions of the rigid structure to form an ornamental treetop. When fully grown around the vertical extension, a trunk is formed which conceals the rigid staking structure. Eventually, the lower portion of the vertical extension and legs are planted underground with the root system of the tree to provide a permanent underground staking system which is firmly anchored, concealed from view, extremely strong and long lasting.

### BRIEF DESCRIPTION OF THE DRAWINGS

For a fuller understanding of the nature of the present invention, reference should be made to the following detailed description taken in conjunction with the accompanying drawings in which:

FIG. 1 is perspective view of the rigid staking structure of the present invention in accordance with one embodiment thereof, wherein a planting pot is shown in broken lines;

FIG. 1A is a perspective view of an alternative embodiment of the rigid staking structure showing a circular plate base;

FIG. 2 is a perspective view of the rigid staking structure of the present invention in accordance with a second embodiment thereof;

FIG. 3 is a perspective view of the rigid staking structure in accordance with yet a further embodiment of the invention, wherein a root system, braided trunk and ornamental tree top are shown in broken lines;

FIG. 3A is an isolated elevational view showing the base of the rigid staking structure of the embodiment of FIG. 3 buried below the ground surface along with the root system of the ornamental tree that is supported on the rigid staking structure;

FIG. 4 is a perspective view of yet a further embodiment of the rigid staking structure that includes branch arms welded to and extending from the top of the staking structure, as well ornamental plates in the shape of feet welded to the leg members of the base; and

FIG. 4A is an isolated perspective view taken from the area indicated as 4A in FIG. 4, and illustrating an example of a rigid bar material used in the construction of the rigid staking structure of any of the embodiments disclosed herein, and wherein this particular rigid bar material is commonly referred to as rebar in the construction industry.

Like reference numerals refer to like parts throughout the several views of the drawings.

### DETAILED DESCRIPTION OF THE PREFERRED EMBODIMENTS

Referring to the several views of the drawings, the permanent underground staking apparatus of the present invention is shown in accordance with several embodiments thereof, and is generally indicated as 10 throughout the drawing figures.

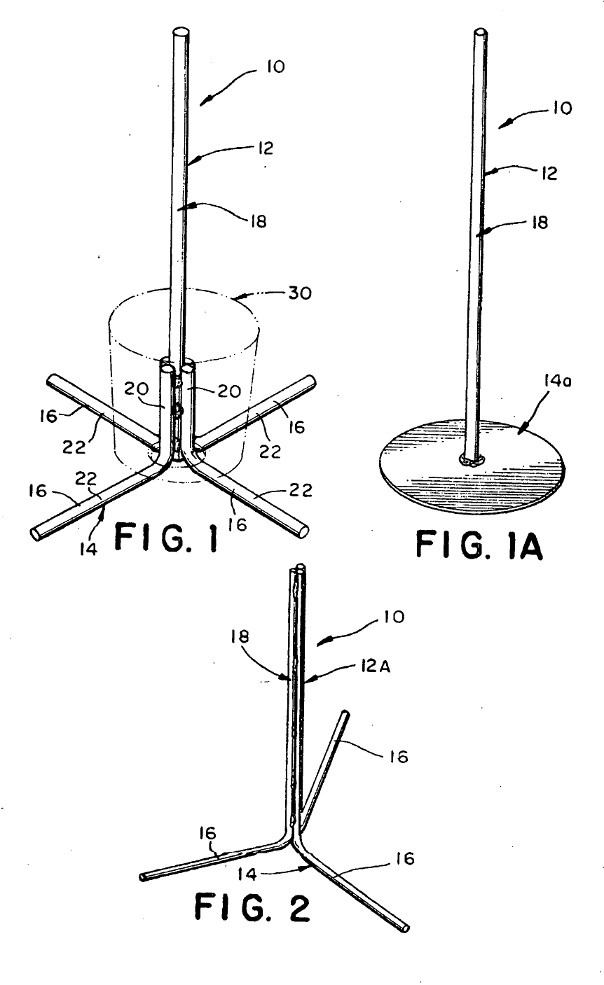

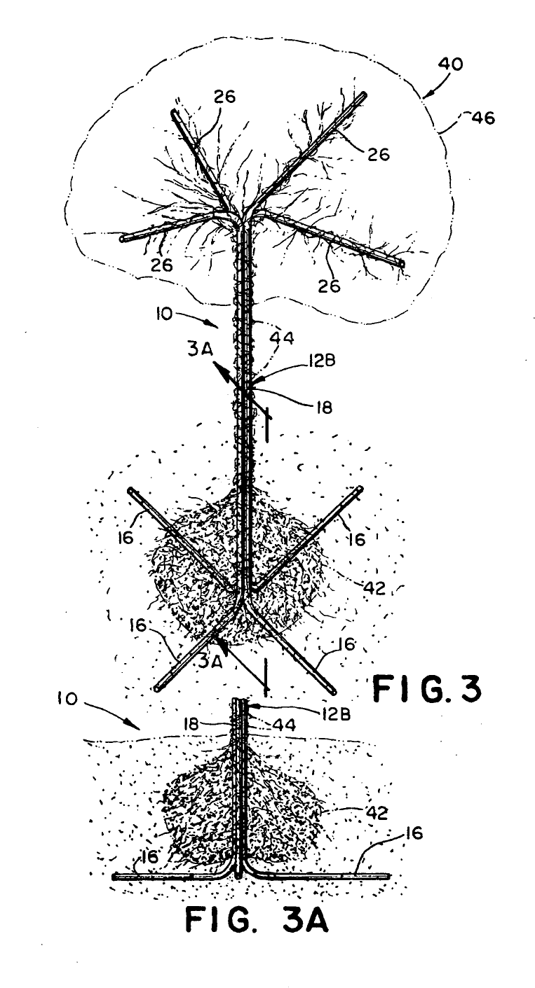

In each of the embodiments, the staking apparatus includes a rigid staking structure 12 having a base 14 and a vertical extension 18 extending upwardly from the base. In several preferred embodiments of the invention, the base is formed by a plurality of legs 16. As seen in the several drawing figures, the legs 16 are preferably perpendicular to the vertical extension 18 and extend outward, generally horizontally, at spaced intervals. It is preferable that the rigid staking structure have at least 3 legs. FIG. 2 shows an example of the base formed with 3 legs, while the embodiments of FIGS. 1 and 3 illustrate a base having 4 legs equally spaced from one another. In a preferred embodiment, the entire rigid staking structure 12 is formed of steel or iron bars, such as steel reinforcing bars that are commonly referred to as rebar in the construction industry. Alternatively, the rigid staking structure maybe formed of cold rolled steel bars to provide a smooth exterior finish. Further embodiments of the invention may provide a painted coating over the steel bar rigid staking structure or other coating materials. Other rigid materials are contemplated within the scope of the invention for use in the manufacture of the staking structure 12 including, but not limited to, aluminum and plastic. However, in the preferred embodiment, the steel reinforcing bar used and it is left bare.

Referring to FIG. 1, the legs 16 may be formed as a separate piece from the vertical extension 18. In this embodiment, the legs 16 are bent at 90 degrees to include a vertical section 20 and a horizontal section 22 which extends outwardly. The vertical section of the bent legs is welded to the lower end of the vertical extension 18. In this embodiment, the vertical extension may be formed with ⅞ inch rebar, while the leg members are formed with one inch rebar that is bent at a 90 degree angle.

In an alternative embodiment, a shown in FIG. 1A, the base may be formed as a flat plate 14a. In this example, the flat plate 14a is round and has a diameter that is approximately half the length of the vertical extension 18.

As shown by example in FIG. 1, the rigid staking structure 12 in any of the embodiments of the invention may be fitted within a planting pot 30 to allow a tree or vines growing in the planting pot to grow upwardly about the vertical extension 18. As the tree stems or vines grow, they are braided about the vertical extension. After growing beyond the top end of the vertical extension 18, the stems or vines are allowed to grow outwardly to form a head or treetop with leaves and blooms. As the stems or vines grow and become thicker they eventually conceal the vertical extension from view. The root base within the planting pot can eventually be planted in the ground, with the horizontal sections of the legs seated well below the ground surface, thereby anchoring the rigid staking structure and tree firmly in the ground. Thereafter, the staking structure 12 remains as a permanent underground staking system which continually supports the tree in an upright position. In this matter, the staking system essentially provides a high strength, reinforcing skeletal structure which is concealed from normal view, thereby allowing an ornamental specimen tree to remain firmly planted in the ground in an upright position, while withstanding external forces of nature such as high winds and heavy rains.

FIG. 2 shows another embodiment of the rigid staking structure which is indicated as 12A. In this embodiment, the legs 16 and vertical extension 18 are formed by three or more sections of rigid bars (e.g. steel, iron, aluminum or plastic), each of equal length. The bars are bent near the bottom to form the legs which extend generally perpendicular to the vertical extension. The longer portion of the rigid bars are welded together to form the vertical extension, with the legs extending outwardly at equally spaced intervals.

FIGS. 3 and 3A show a further embodiment of the invention wherein the rigid staking structure is indicated as 12B. In this embodiment, the rigid bar sections are bent at the top ends to form branch extensions. Similar to the embodiment of FIG. 2, the bottom ends of these rigid bars are bent outwardly to form the legs 16 while the mid-section of the rigid bar sections are welded together to form the vertical extension 18. An ornamental tree 40 is shown in broken lines and supported by the staking structure. Specifically, a root base 42 is shown at the base of the staking structure, with a braided trunk extending upwardly along the vertical extension to an ornamental treetop 46 which is grown outwardly along the branch extensions. In this embodiment, the branch extensions 26 serve to further support the growing vines or branch stems to maintain the integrity and shape of the ornamental treetop 46. It should be noted that the branch extensions 26 may be formed as a separate piece and welded to the vertical extension, similar to the legs in the embodiment of FIG. 1.

In each of the embodiments, it is preferred that the base 16 be of an overall length of approximately ½ of the overall height of the vertical extension 18. This ratio between the base length and vertical extension height helps to achieve the desired stability and anchoring when the base 14 is planted below the ground surface along with the root system.

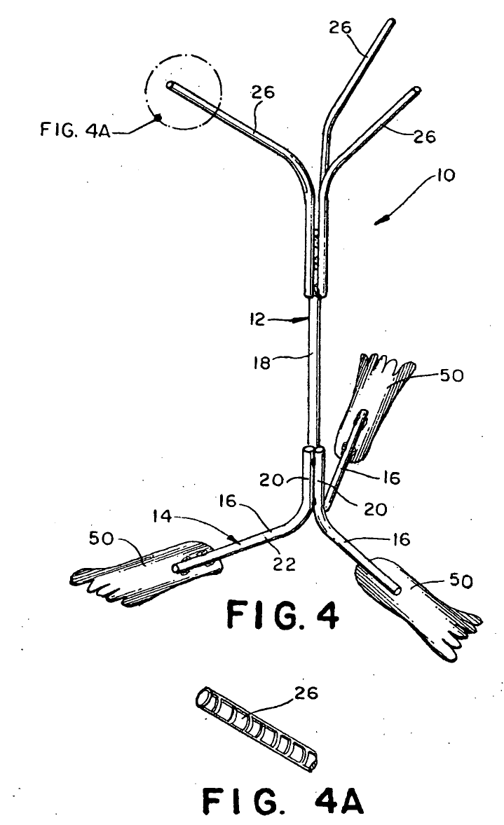

Referring to FIG. 4, the rigid staking structure 12 is shown to include a single vertical post 18, similar to the embodiment of FIG. 1, with a plurality of legs 16 welded to the vertical post extension 18, as well as branch extensions 26 welded to and extending outwardly at various angles from the top portion of the vertical extension 18. In this particular embodiment, as illustrated in FIG. 4, ornamental plate members 50 in the shape of feet are welded to the ends of the legs 16. The ornamental feet plates 50 provide added stability to the staking structure 12 when resting on a floor surface. Additionally, the ornamental feet plates 50 provide additional anchoring strength and resistance to uprooting when the base of the staking structure 18 is planted below the ground surface to support a planted tree.

As described above, the rigid material used in the construction of the staking structure 12 may be of any suitable material that provides sufficient weight and resistance to flexing and bending in order to firmly anchor and support a growing vine plant or tree. The material used in the construction of the rigid staking structure should be of sufficient strength to withstand the forces of nature, and particularly high winds and driving rain. It is preferred that the rigid staking structure be constructed from one or more sections of a rigid metal bar material that can be formed to the desired shape by bending under great force that is far greater than those forces exerted on planted trees in nature. The use of a rigid metal bar material also provides substantial weight to the rigid staking structure 12, and particularly the base 14. FIG. 4A is an isolated view taken from the area indicated as 4A in FIG. 4 and depicts a rigid steel bar material. commonly referred to as rebar in the construction industry. The use of this type of rigid bar material is particularly ideal for use in the construction of the rigid staking structure 121.

While the present invention has been shown and described in accordance with several preferred and practical embodiments, it is recognized that the departures from the instant disclosure are contemplated with the spirit and scope of the present invention.

What is claimed is:

1. A staking apparatus for vines and trees comprising:
a rigid base normally disposed along a horizontal plane, and
an elongate rigid vertical extension fixed with said base as a rigid unit and said vertical extension extending upwardly and away from said base to a top distal end, and said rigid vertical extension providing a permanent skeletal tree trunk.

2. The apparatus as recited in claim 1 wherein said rigid vase is defined by a plurality of rigid legs.

3. The apparatus as recited in claim 2 wherein said rigid legs are formed of solid metal bars.

4. The apparatus as recited in claim 3 wherein said rigid vertical extension is formed of at least one solid metal bar.

5. The apparatus as recited in claim 4 wherein said solid metal bars forming said rigid legs and said rigid vertical extension are iron bars.

6. The apparatus as recited in claim 4 wherein said solid metal bars forming said rigid legs and rigid vertical extension are steel bars.

7. The apparatus as recited in claim 4 wherein said solid metal bars forming said rigid legs and said rigid vertical extension are aluminum bars.

8. The apparatus as recited in claim 1 further comprising a plurality of branch members fixed to said rigid vertical extension and extending away form said top distal end.

9. The apparatus as recited in claim 8 wherein said branch members are bendable to assume selected angular positions relative to said rigid vertical extension.

10. A staking apparatus for vines and trees comprising:
a rigid base including a plurality of leg members normally extending along a horizontal plane;
an elongate rigid extension fixed with said base as a rigid integral unit, and said rigid vertical extension extending upwardly and away from said base to a top distal end, and said rigid extension providing a permanent skeletal tree trunk.

11. The apparatus as recited in claim 10 wherein said plurality of leg members are formed of solid metal bars.

12. The apparatus as recited in claim 11 wherein said elongate rigid extension is formed of at least one solid metal bar.

13. The apparatus as recited in claim 12 wherein said solid metal bars forming said rigid legs and said elongate rigid extension are iron bars.

14. The apparatus as recited in claim 12 wherein said solid metal bars forming said rigid legs and said elongate rigid extension are steel bars.

15. The apparatus as recited in claim 12 wherein said solid metal bars forming said rigid legs and said elongate rigid extension are aluminum bars.

16. The apparatus as recited in claim 10 further comprising a plurality of branch members fixed to said elongate rigid extension and extending away from said top distal end.

17. The apparatus as recited in claim 16 wherein said branch members are bendable to assume selected angular positions relative to said elongate rigid extension.
